(19) United States
(12) Patent Application Publication
(10) Pub. No.: US 2025/0203662 A1
(43) Pub. Date: Jun. 19, 2025

(54) METHOD AND APPARATUS FOR SMALL DATA TRANSMISSION

(71) Applicant: Nokia Technologies Oy, Espoo (FI)

(72) Inventors: Samuli Heikki TURTINEN, Oulu (FI); Jussi-Pekka KOSKINEN, Oulu (FI); Chunli WU, Beijing (CN); Karri Markus RANTA-AHO, Espoo (FI)

(21) Appl. No.: 18/846,933

(22) PCT Filed: Apr. 22, 2022
(86) PCT No.: PCT/CN2022/088586

§ 371 Date: Sep. 13, 2024

(51) Int. Cl. H04W 74/0833

(52) U.S. Cl. CPC H04W 74/0833

(57) ABSTRACT

Embodiments of the present disclosure relate to small data transmission. A terminal device performs a transmission, in a small data transmission, SDT, procedure utilizing a resource associated with a selected Synchronization Signal and PBCH block, SSB. The selected SSB is selected from one or more SSBs available for the SDT procedure. And monitor the selected SSB for a downlink, DL, reception for a period of time. The period of time is based on at least one of: a timer, a time window, a counter of slot, a part of the SDT procedure. The solution for SDT as provided in the present disclosure can keep the DL SSB consistent between terminal device and the network device during the SDT procedure.

### FIELD

Embodiments of the present disclosure generally relate to the field of telecommunication and in particular, to a method, device, apparatus and computer readable storage medium for small data transmission (SDT).

### BACKGROUND

For a terminal device in a radio resource control (RRC) idle mode or a RRC inactive mode, signals for transitioning to a RRC connected mode and maintaining the RRC connected mode may cause large overheads (e.g., power consumption and delay) when it has small amount of data (small data) to be transmitted.

With developments of communication systems, SDT technologies have been proposed to reduce the signaling overhead and delay by avoiding transiting to RRC connected mode. New Radio (NR) system supports both random access channel (RACH) based SDT (i.e., RA-SDT) and configured grant (CG) based SDT (i.e. CG-SDT). In a RA-SDT procedure, a terminal device is enabled to transmit small data in the RRC inactive mode using an uplink grant received via a random access (RA) procedure for SDT. In a CG-SDT procedure, the terminal device is enabled to transmit small data in the RRC inactive mode using uplink resources pre-configured.

### SUMMARY

In general, example embodiments of the present disclosure provide a solution for small data transmission.

In a first aspect, there is provided a terminal device. The terminal device comprises at least one processor; and at least one memory including computer program codes. The at least one memory and the computer program codes are configured to, with the at least one processor, cause the terminal device to: perform a transmission, in a small data transmission, SDT, procedure utilizing a resource associated with a selected Synchronization Signal and PBCH block, SSB, wherein the selected SSB is selected from one or more SSBs available for the SDT procedure; and monitor the selected SSB for a downlink, DL, reception for a period of time, wherein the period of time is based on at least one of: a timer, a time window, a counter of slot, a part of the SDT procedure.

In a second aspect, there is provided a terminal device. The terminal device comprises at least one processor; and at least one memory including computer program codes. The at least one memory and the computer program codes are configured to, with the at least one processor, cause the terminal device to: perform an transmission, in small data transmission, SDT, procedure utilizing a resource associated with a selected Synchronization Signal and PBCH block, SSB, wherein the SSB is selected from one or more SSBs available for the SDT procedure; and monitor the selected SSB for a downlink, DL, reception for a period of time, wherein the period of time is dependent on at least quality of the selected SSB.

In a third aspect, there is provided a network device. The device comprises at least one processor; and at least one memory including computer program codes; wherein the at least one memory and the computer program codes are configured to, with the at least one processor, cause the network device to: configure a period of time for a terminal device by a higher layer signaling, wherein the terminal device is configured to monitor a SSB for a downlink, DL, reception for the period of time, and wherein the period of time is indicated by any one of: a timer, a time window, a counter of slot, a part of the SDT procedure for the terminal device.

In a fourth aspect, there is provided a method implemented at a terminal device. The method comprises performing a transmission, in a small data transmission, SDT, procedure utilizing a resource associated with a selected Synchronization Signal and PBCH block, SSB, wherein the SSB is selected from one or more SSBs available for the SDT procedure; and monitoring the selected SSB for a downlink, DL, reception for a period of time, wherein the period of time is based on at least one of: a timer, a time window, a counter of slot, a part of the SDT procedure.

In a fifth aspect, there is provided a method implemented at a terminal device. The method comprises performing an transmission, in small data transmission, SDT, procedure utilizing a resource associated with a selected Synchronization Signal and PBCH block, SSB, wherein the SSB is selected from one or more SSBs available for the SDT procedure; and monitoring the selected SSB for a downlink, DL, reception for a period of time, wherein the period of time is dependent on at least quality of the selected SSB.

In a sixth aspect, there is provided a method implemented at a network device. The method comprises configuring a period of time for a terminal device by a higher layer signaling, wherein the terminal device is configured to monitor a SSB for a downlink, DL, reception for the period of time, wherein the period of time is indicated by any of length of: a timer, a time window, a counter of slot, a part of the SDT procedure for the terminal device.

In a seventh aspect, there is provided an apparatus comprising means for performing a transmission, in a small data transmission, SDT, procedure utilizing a resource associated with a selected Synchronization Signal and PBCH block, SSB, wherein the SSB is selected from one or more SSBs available for the SDT procedure; and means for monitoring the selected SSB for a downlink, DL, reception for a period of time, wherein the period of time is based on at least one of: a timer, a time window, a counter of slot, a part of the SDT procedure.

In an eighth aspect, there is provided an apparatus comprising means for means for performing an transmission, in small data transmission, SDT, procedure utilizing a resource associated with a selected Synchronization Signal and PBCH block, SSB, wherein the SSB is selected from one or more SSBs available for the SDT procedure; and means for monitoring the selected SSB for a downlink, DL, reception for a period of time, wherein the period of time is dependent on at least quality of the selected SSB.

In a ninth aspect, there is provided an apparatus comprising means for configuring a period of time for a terminal device by a higher layer signaling, wherein the terminal device is configured to monitor a SSB for a downlink, DL, reception for the period of time, and wherein the period of time is indicated by any of length of: a timer, a time window or a counter of slot, a part of the SDT procedure for the terminal device.

In a tenth aspect, there is provided a non-transitory computer readable medium comprising program instructions for causing an apparatus to perform at least the method according to any one of the above fourth to sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates a flowchart of a method implemented at a terminal device according to some embodiments of the present disclosure;

FIG. 3 illustrates a flowchart of a method implemented at a terminal device according to some embodiments of the present disclosure;

FIG. 4 illustrates a flowchart of a method implemented at a network device according to some other embodiments of the present disclosure;

FIG. 5 illustrates a flowchart illustrating a process for small data transmission according to some embodiments of the present disclosure;

FIG. 6a illustrates a diagram illustrating the SSB for small data transmission according to some embodiments of the present disclosure;

FIG. 6b illustrates another diagram illustrating the SSB for small data transmission according to some embodiments of the present disclosure;

FIG. 6c illustrates a further diagram illustrating the SSB for small data transmission according to some embodiments of the present disclosure;

FIG. 7 illustrates a simplified block diagram of an apparatus that is suitable for implementing embodiments of the present disclosure; and

FIG. 8 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element may be termed a second element, and similarly, a second element may be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the future fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), an Integrated Access and Backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

As discussed above, SDT technologies have been proposed to reduce the signaling overhead and delay avoiding transiting to RRC connected mode and currently the NR system supports both RACH based SDT (i.e., RA-SDT) and CG based SDT (i.e. CG-SDT).

According to Radio Access Network (RAN) Working Group (WG) 1 (RAN1) agreements and assumptions, the terminal device selects a synchronization signal (SS)/physical broadcast channel (PBCH) block (SSB) (refers as selected SSB/PBCH in the present disclosure) for downlink monitoring, and the SSB/PBCH is associated with a resource for an uplink transmission (e.g. CG resources associated with the SSB/PBCH) of an initial transmission phase. It is assumed that the selected SSB/PBCH will be used during the whole SDT procedure according to RAN1's agreements. While RAN WG 2 (RAN2) specified that the terminal device can use any resources associate with any SSB whose quality (e.g. Reference Signal Receiving Power RSRP) is above a threshold.

From RAN2 point of view, the CG resources during the procedure of small data transmission may be changed, and the monitoring of downlink SSB/PBCH may change during the SDT procedure. Therefore the assumption of RAN1 and RAN2 is different for small data transmission.

It is to be understood that, in generally, there is a correspondence between an SSB and a beam. Therefore, the procedure for beam management also can be implemented by SSB management according to the above correspondence. As used herein, the terms “beam” and “SSB” are equivalent with each other or can be used interchangeably. In the following, the example embodiments are discussed by using the term of “SSB”. It is to be understood that all the discussion about “SSB” is equally applicable to the “beam”. In another example, the “beam” may be a CSI-RS (Channel State Information Reference Signal) and, hence, it is to be understood that all the discussion about “SSB” is equally applicable to the “CSI-RS”.

According to embodiments of the present disclosure, there is providing a solution for SDT to keep the DL SSB consistent between UE and the NW during the SDT procedure. In the communication network, for a SDT procedure between the terminal device and the network device, a period of time (such as timer, time window, counter of slot, a part of the SDT procedure, etc) may be pre-determined, for example configured by the network device; during the period of time, the terminal device assumes DL reception from a specific SSB keeps unchanged.

In one possible embodiment, the terminal device may re-select a DL reception SSB (such as the next SSB, a new SSB, or the same SSB) for a subsequent transmission in the SDT procedure and starts a new period of time. As such, it is possible to change the DL SSB for DL reception monitoring of the SDT transmission and keep the SDT procedure succeeding for the most of the time. Alternatively or additionally, the period of time may depend on at least quality of the selected and/or re-selected SSB.

Although functionalities described herein can be performed, in various example embodiments, in a fixed and/or a wireless network node may, in other example embodiments, functionalities may be implemented in user equipment (such as a cell phone or tablet computer or laptop computer or desktop computer or mobile IOT device or fixed IOT device). This user equipment may, for example, be furnished with corresponding capabilities as described in connection with the fixed and/or the wireless network node(s), as appropriate. The user equipment may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

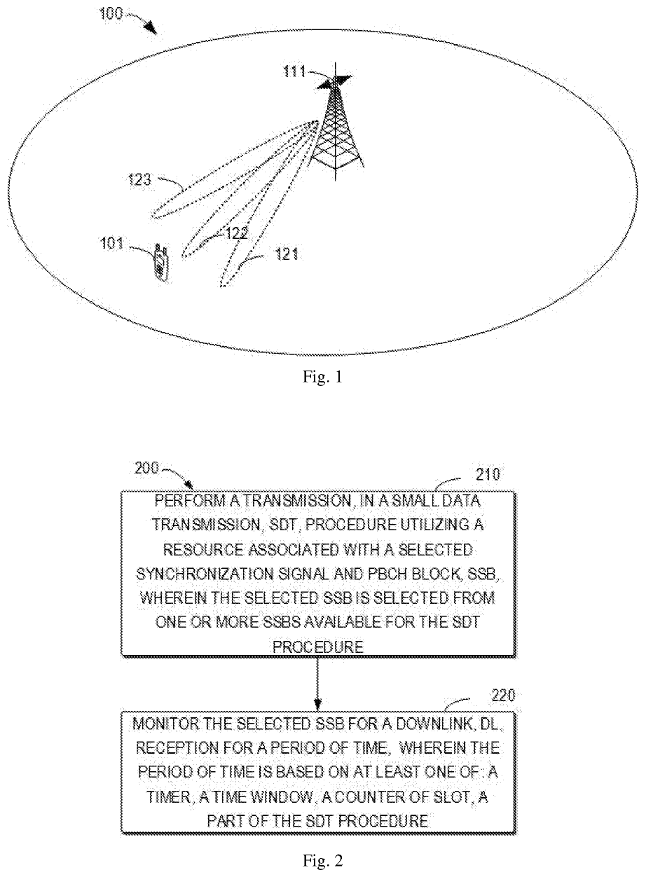

Principle and embodiments of the present disclosure will be described in detail below with reference to the accompanying drawings. Reference is first made to FIG. 1, which illustrates an example communication system 100 in which embodiments of the present disclosure may be implemented. The system 100 includes a network device, such as a network device 111. The network device 111 serves terminal devices using a plurality of SSBs in the SDT procedure, such as SSB 121, SSB 122 and SSB 123.

The system 100 also includes terminal devices, such as a terminal device 101. The terminal device 101 is capable of connecting and communicating with the network devices 111 via the SSBs, to perform, e.g., an SDT procedure. In communication systems, UL refers to a communication link in a direction from a terminal device to a network device, and DL refers to a communication link in a direction from the network device to the terminal device.

It is to be understood that the number of network devices and terminal devices is only for the purpose of illustration without suggesting any limitations. The system 100 may include any suitable number of network devices and terminal devices adapted for implementing embodiments of the present disclosure.

Communications in the communication system 100 may be implemented according to any proper communication protocol(s), comprising, but not limited to, cellular communication protocols of the third generation (3G), the fourth generation (4G) and the fifth generation (5G) or beyond, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

For SDT between the terminal device 101 and network device 111, either the terminal device 101 or network device 111 can initiate an SDT procedure. Then the terminal device 101 may select a resource associates with a SSB and performs an UL transmission in a SDT procedure, for example, SSB 121. The SSB 121 is selected from one or more available SSBs for monitoring DL response of the SDT in any suitable SSB selection strategy, such as using a quality criterion. For example, an SSB with Reference Signal Received Power (RSRP) value above a predetermined threshold can be selected for the UL transmission. The network device 111 may respond to the terminal device 101 via the SSB 121. Accordingly, the terminal device 101 monitors the SSB 121 for DL reception for a period of time.

In some scenarios, a period of time can be measured by timer, time window, count of slot, a part of the SDT procedure. And the part of the SDT procedure may be initial transmission duration of SDT procedure or subsequent transmission duration of SDT procedure. For instance, the initial transmission duration of SDT may comprise the transmission and possible re-transmissions of the first message of the SDT procedure by the terminal device 101 and the DL response by the network device 111. The first message may comprise at least a CCCH (Common Control Channel) SDU (Service Data Unit). For instance, the subsequent transmission duration of SDT procedure may comprise the rest of the SDT procedure duration after the initial transmission duration of the SDT procedure. For example, the terminal device 101 and network device 111 maintain a timer separately. The timer may be started/restarted for the initial transmission in the SDT procedure, and/or any subsequent transmission in the SDT procedure. Additionally or alternatively, the timer may be restarted upon reception of a response on the SSB associated with the UL transmission or upon reception of any DL transmission on the SSB so as to extend the period of time for further SDT for DL monitoring on the same SSB, e.g. when the quality of the selected resource associated with the SSB is over a particular threshold or DL transmissions can be decoded on the SSB.

In some embodiments, during the period of time, the terminal device 101 may monitor the selected SSB, that is, SSB121, for a DL reception; when the timer expires, the terminal device 101 may perform a subsequent transmission via any configured resources associated with any SSBs with the quality above a threshold level. For example, when the timer expires, a resource associated with the SSB 122 is selected for subsequent transmission and the timer will be started. In such a case, the terminal device 101 may perform another UL transmission via the resource(s) associated with SSB 122 in the SDT procedure. Then the SSB 122 may be a re-selected SSB or the current “selected SSB”. In such a case, the network device 111 responds to the terminal device 101 via the SSB 122, e.g., when the timer is running. The terminal device 101 monitors the SSB 122 for DL reception accordingly.

In some embodiments, the terminal device 101 performs another UL transmission in the SDT procedure utilizing resource(s) associated with the selected SSB until the period of time is expired. So the SSB for UL and DL transmission in the SDT procedure will not be changed during the period of time, for example, while the timer is running.

Alternatively, or additionally, the terminal device 101 may perform another UL transmission in the SDT procedure utilizing a resource associated with another SSB different from the selected SSB during the period of time. Another SSB may be any available SSB, for example an SSB whose quality is above a threshold. And meanwhile, the SSB for DL reception will not be changed during the period of time, for example, while the timer is running. In other words, terminal device 111 may perform UL transmission via resource associated with more than one SSB, but monitors only the selected SSB for DL reception during the period of time, for example, while the timer is running.

Alternatively, or additionally, in case of re-selecting resources associated with SSB 122 for the other UL transmission, the terminal device 101 may stop monitoring the previously selected SSB 121 but monitor the SSB 122 for the DL transmission. The network device may use the SSB 122 for the DL transmission after receiving UL transmission on the SSB 122 from the terminal device. Additionally, the terminal device may restart the timer for DL reception to set another period of time for the SSB 122. Or alternatively, the SSB for DL reception monitored by the terminal device may be changed when the terminal device 101 further selects another resource associated with SSB for subsequent UL transmissions.

Alternatively, or additionally, in case of re-selecting resource associated with SSB for the other UL transmission, the terminal device 101 may continue monitoring the previously selected SSB 121 before the expiration of the timer, while monitoring the SSB 122 for the DL transmission. In such a case, the UE may start another timer for the SSB 122 if two timers for DL reception are supported by the terminal device. Meanwhile, the network device may use any of previously selected SSB 121 and the SSB122.

In some scenarios, the period of time is just dependent on the quality of the selected SSB. For example, the terminal device 101 measures the RSRP of selected SSB. If the RSRP of selected SSB is above a threshold, the selected SSB will not be changed. Otherwise, the terminal device 101 will select another SSB with an RSRP above the threshold as a new selected SSB for the SDT procedure.

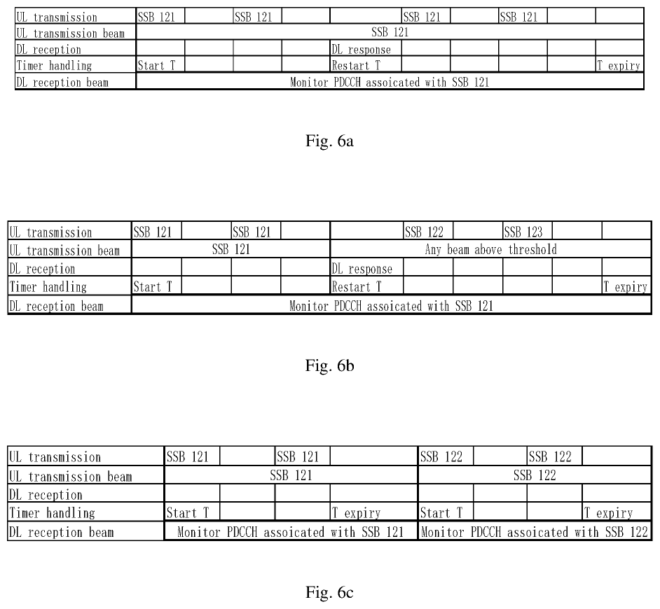

FIG. 2 shows a flowchart of an example method 200 implemented at a terminal device in accordance with some embodiments of the present disclosure. For the purpose of discussion, the method 200 will be described from the perspective of the terminal device 101 with reference to FIG. 1. And the method 200 will be described with reference to FIGS. 6a, 6b and 6c also.

At block 210, the terminal device 101 performs a transmission, in an SDT procedure utilizing a resource associated with a selected SSB, wherein the selected SSB is selected from one or more SSBs available for the SDT procedure.

At block 220, the terminal device 101 monitors the selected SSB for DL, reception for a period of time, wherein the period of time is based on at least one of: a timer, a time window or a counter of slot, a part of the SDT procedure.

In some embodiments, the period of time is configured by a higher layer signaling. As an example, the network device may configure the period of time for the terminal device 101 via an RRC signaling.

In some embodiments, the period of time may be further extended upon any DL reception on the selected SSB 121. For example, the period of time is extended by any of: restarting the timer; extending the time window; and resetting the counter of slot.

Reference is made to FIG. 6a to describe an example of extension of the period of time. FIG. 6a illustrates SSB for small data transmission according to some example embodiments of the present disclosure.

As illustrated in FIG. 6a, the first row of blocks represent UL transmissions, the second row of block represents resources associated with the SSB for the SDT procedure, the third row of blocks represent the DL receptions, the fourth row of blocks represent handling of the timer for monitoring the DL reception associated with specific SSB, and the fifth row of blocks represent the beam for DL reception. It is to be understood that the numbers and their correspondence of timer, transmission occasion and candidate beam shown FIG. 6a are only for the purpose of illustration without suggesting any limitations.

In the example of FIG. 6a, for example, three candidate SSBs (i.e., SSB 121, SSB 122 and SSB 123) are available for the SDT. The terminal device 101 initiates a SDT procedure via a resource associated with SSB 121, and meanwhile a timer is started. Thereafter, the terminal device 101 monitors the SSB 121 for DL reception. When the terminal device 101 receives a DL reception via SSB 121, the timer can be restarted to extend the time period. The DL reception may be a response to one of previous UL transmissions or any other transmission from the network device. Accordingly, the terminal device 101 monitors the SSB 121 for DL reception continually before the expiration of timer.

In some embodiments, the terminal device 101 performs, another uplink, UL, transmission in the SDT procedure utilizing a resource associated with the selected SSB until the period of time is expired. In other words, the SSB for the UL transmission will not be changed before expiration of the period of time. For example, as illustrated in FIG. 6a, the terminal device 101 performs the UL SDT via a resource associated with SSB 121 until the timer is expired. Upon expiration of the timer, the terminal device can select an SSB for the following SDT procedure.

In some embodiments, the terminal device 101 performs another UL transmission in the SDT procedure utilizing a resource associated with another SSB during the period of time. In some embodiments, the resource associated with another SSB for the other UL transmission is reselected after a DL reception on the selected SSB. Reference can be made to FIG. 6b, which illustrates a schematic diagram for small data transmission according to some example embodiments of the present disclosure.

As illustrated in FIG. 6b, the terminal device 101 initiates a SDT procedure via a resource associated with SSB 121 and meanwhile a timer is started. The terminal device 101 performs the UL transmission via a resource associated with SSB 121. After the terminal device 101 receives a DL reception (e.g., a DL response to one of previous UL transmission), the terminal device 101 is allowed to change resources associated with available SSBs for UL freely. For example, the terminal device 101 may select any SSB above a threshold of quality, SSB 122 for example. In such a case, the terminal device 101 performs following UL transmission via the resource associated with SSB 122 and the resource associated with SSB 123 respectively. However the network device will still using SSB121 to perform DL transmission, and thus the terminal device 101 still monitor SSB 121, which is the originally selected SSB upon starting of the timer, for DL reception until the timer expires.

In some embodiments, the terminal device 101 starts a new timer for the other SSBs, such as SSB 122 and SSB 123. The network device 111 may respond to the terminal device 101 via both the original selected SSB and the other SSBs when the respective timers are running. The terminal device 101 may monitor both original selected SSB and other SSBs for DL reception when the respective timers are running. Monitoring both original selected SSB and other SSBs for DL reception may depend on the capability of the terminal device 101.

In some embodiments, the solution as mentioned above can be applied in initial transmission in the SDT procedure. The initial transmission comprises the first UL transmission and subsequent retransmission of the UL transmission after the SDT procedure is triggered.

The solution as mentioned above can be applied in a subsequent UL transmission in the SDT procedure. The subsequent transmission comprises the transmissions except the initial transmission in whole SDT procedure.

In some embodiments, for subsequent transmission in the SDT procedure, a SSB may be reselected during the SDT procedure. That means that the initial transmission and subsequent transmission may use different e.g. CG resources for SDT, but SSB for DL reception for different CG resources is the same.

In some embodiments, in accordance with determination of no DL reception before the period of time expires, the terminal device 101 may start another transmission in the SDT procedure utilizing a resource associates with another SSB different from the selected SBB, and monitors the another SSB for a DL reception for another period of time.

For example, reference is made to FIG. 6c, which illustrated SSB for small data transmission according to some example embodiments of the present disclosure. As illustrated in FIG. 6c, the terminal device 101 initiates a SDT procedure via a resource associated with SSB 121. And a timer is started. The terminal device 101 monitors the SSB 121 for DL reception. But no DL reception is received until the timer expires. So the terminal device 101 starts another UL transmission via a resource associated with SSB 122, and monitors the SSB 122 for DL reception, a timer is started or restarted when an UL small data transmission is done.

In some embodiments, the period of time is extended if quality of the selected SSB is above a threshold when the period of time expires.

It is to be noted that the above embodiments can be applied in both the CG based SDT procedure or a RACH based procedure.

In some embodiments, the terminal device 101 performs a RA procedure when the quality of the selected SSB is below a threshold. The RA procedure is used to indicate a new SSB to the network device for DL reception. In this case, resources other than the resources associated with the selected SSB may be released/suspended after the initial transmission.

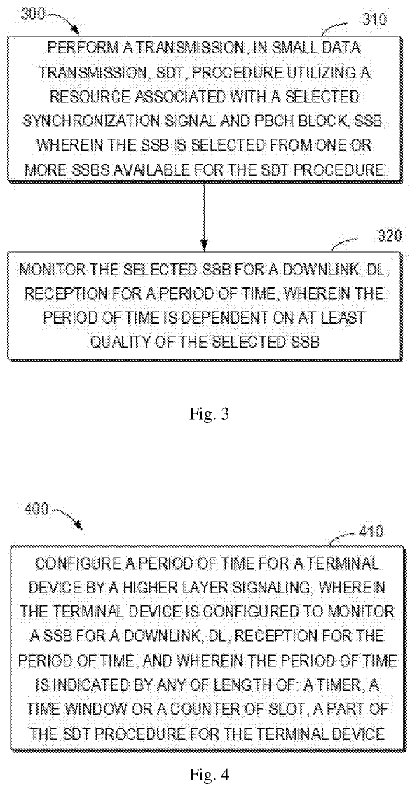

FIG. 3 shows a flowchart of an example method 300 implemented at a terminal device in accordance with some embodiments of the present disclosure. For the purpose of discussion, the method 300 will be described from the perspective of the terminal device 101 with reference to FIG. 1.

At block 310, the terminal device 101 performs a transmission, in small data transmission, SDT, procedure utilizing a resource associated with a selected Synchronization Signal and PBCH block, SSB, wherein the SSB is selected from one or more SSBs available for the SDT procedure.

At block 320, the terminal device 101 monitors the selected SSB for a downlink, DL, reception for a period of time, wherein the period of time is dependent on at least quality of the selected SSB.

In some embodiments, the period of time expiries in accordance with determination that quality of the selected SSB is below a threshold. For example, the terminal device 101 initiate a SDT procedure via a resource associated with SSB 121, and the RSRP of SSB 121 is above a threshold. The terminal device 101 measures the RSRP of SSB 121. If the RSRP of selected SSB is above a threshold, the selected SSB will not be changed. And terminal monitors SSB 121 for DL reception continually. Otherwise, terminal device 101 will select another SSB as “selected SSB”. The RSRP of new “selected SSB” is above the threshold.

In some embodiments, UL SDT is performed based on a configured grant, CG.

In some embodiments, UL SDT is performed based on a random access channel, RACH procedure.

In some embodiments, the terminal device 101 performs a RA procedure when the quality of the selected SSB is below a threshold.

FIG. 4 shows a flowchart of an example method 400 implemented at a network device in accordance with some embodiments of the present disclosure. For the purpose of discussion, the method 400 will be described from the perspective of the network device 111 with reference to FIG. 1.

At block 410, the network device 111 configures a period of time for a terminal device by a higher layer signaling. The terminal device is configured to monitor a SSB for a downlink, DL, reception for a period of time, and wherein the period of time is indicated by any one of: a timer, a time window, a counter of slot, a part of the SDT procedure for the terminal device.

In some embodiments, to simplify implementation of the network device 111, the network device uses the SSB, which is associated with the resource performing the recent UL transmission, as the DL SSB.

In some embodiments, the network device 111 may also follow similar timer to enable the time period of a first selected SSB. For example the network device may receive, from the terminal device, an UL transmission in SDT procedure, utilizing a resource associated with SSB. The SSB is selected by the terminal device from one or more SSBs available for the SDT. The network device performs a DL, transmission, utilizing a resource associated with the selected SSB for a period of time, wherein the period of time is based on at least one of: a timer, a time window or a counter of slot, a part of the SDT procedure at the network device.

In some embodiments, the period of time is extended upon any DL transmission on the selected SSB.

In some embodiments, the period of time is extended by any of: restarting the timer; extending the time window; and resetting the counter of slot.

In some embodiments, the network device 111 receives, another UL transmission in the SDT procedure utilizing a resource associated with the selected SSB until the period of time is expired.

In some embodiments, the network device 111 receives, another UL transmission in the SDT procedure utilizing a resource associated with another SSB different from the selected SBB during the period of time.

In some embodiments, a SSB is reselected after any DL transmission on the selected SSB.

In some embodiments, the transmission is an initial transmission in the SDT procedure.

In some embodiments, the transmission is a subsequent transmission in the SDT procedure.

For subsequent transmission in the SDT procedure, another SSB is reselected for performing the SDT procedure.

In some embodiments, the SDT procedure is performed based on configured grant, CG.

In some embodiments, the SDT procedure is performed based on random access channel, RACH.

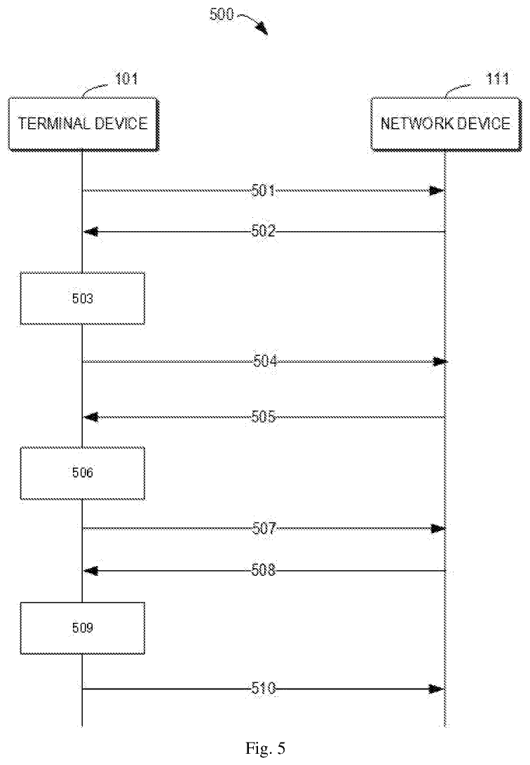

Reference is now made to FIG. 5, which shows a process 500 for small data transmission according to an embodiment of the present disclosure. For the purpose of discussion, the process 500 will be described with reference to FIG. 1. The process 500 may involve the terminal device 101 and the network device 111 as illustrated in FIG. 1. It would be appreciated that although the process 500 has been described in the communication system 100 of FIG. 1, this process may be likewise applied to other communication scenarios where different network devices are jointly deployed to provide respective serving cells. It would also be appreciated that although the small data transmission of the terminal device 101 is discussed, a similar process can be applied for any other terminal devices. Besides, an example CG based SDT procedure is given in FIG. 5 as an example but the present disclosure is not limited thereto, similar procedure can be applied to the RACH based SDT procedure.

In the process 500, the terminal device 101 initiates 501 a CG-SDT transmission via a CG resource and starts a new timer. The CG resource is associated with selected SSB. The network device 111 performs 502 DL transmission to the terminal device via the selected SSB. The DL transmission may involve a response to UL transmission or any transmission to the terminal device on the selected SSB for example a CG. The terminal device 101 monitors the selected SSB for DL reception while the timer is running. The terminal device 101 performs 504 CG-SDT transmissions via selected SSB. Or alternatively, the terminal device 101 may be allowed to select another resource associated with another SSB and thus perform CG-SDT via any CG resource associates with any SSB with RSRP above the RSRP threshold. The network device 111 responds 505 still via the selected SSB. The terminal device 101 monitors 506 the selected SSB for DL reception. If the timer expires, the terminal device is allowed to select another SSB and the timer may be restarted.

After the timer expires, the terminal device performs a new UL transmission using resources from a different SSBs and restarting the timer. The terminal device 101 performs 507 another CG-SDT transmission using any CG resource associates with any SSB with RSRP above threshold. The network device 111 responds 508 to the terminal device 101 via the new SSB. The terminal device 101 monitors 509 the new SSB for DL reception while the timer is running. The terminal device 101 performs 510 another CG-SDT transmission in a similar way to 504.

In some embodiments, an apparatus capable of performing any of the method 200 (for example, the terminal device 101) may comprise means for performing the respective steps of the method 200. The means may be implemented in any suitable form. For example, the means may be implemented in a circuitry or software module.

In some embodiments, the apparatus comprises means for performing a transmission, in a small data transmission, SDT, procedure utilizing a resource associated with a selected Synchronization Signal and PBCH block, SSB, wherein the SSB is selected from one or more SSBs available for the SDT procedure; and means for monitoring the selected SSB for a downlink, DL, reception for a period of time, wherein the period of time is based on at least one of: a timer, a time window, a counter of slot, a part of the SDT procedure.

In some embodiments, the apparatus further comprises means for performing other steps in some embodiments of the method 200. In some embodiments, the means comprises at least one processor; and at least one memory including computer program code, the at least one memory and computer program code configured to, with the at least one processor, cause the performance of the apparatus.

In some embodiments, an apparatus capable of performing any of the method 300 (for example, the terminal device 101) may comprise means for performing the respective steps of the method 300. The means may be implemented in any suitable form. For example, the means may be implemented in a circuitry or software module.

In some embodiments, the apparatus comprises: means for performing an transmission, in small data transmission, SDT, procedure utilizing a resource associated with a selected Synchronization Signal and PBCH block, SSB, wherein the SSB is selected from one or more SSBs available for the SDT procedure; and means for monitoring the selected SSB for a downlink, DL, reception for a period of time, wherein the period of time is dependent on at least quality of the selected SSB.

In some embodiments, the apparatus further comprises means for performing other steps in some embodiments of the method 300. In some embodiments, the means comprises at least one processor; and at least one memory including computer program code, the at least one memory and computer program code configured to, with the at least one processor, cause the performance of the apparatus.

In some embodiments, an apparatus capable of performing any of the method 400 (for example, the network device 111) may comprise means for performing the respective steps of the method 400. The means may be implemented in any suitable form. For example, the means may be implemented in a circuitry or software module.

In some embodiments, the apparatus comprises: means for configuring a period of time for a terminal device by e.g. a higher layer signaling, wherein the terminal device is configured to monitor a SSB for a downlink, DL, reception for the period of time, and wherein the period of time is indicated by any one of: a timer, a time window, a counter of slot, a part of the SDT procedure for the terminal device.

In some embodiments, the apparatus further comprises means for performing other steps in some embodiments of the method 400. In some embodiments, the means comprises at least one processor; and at least one memory including computer program code, the at least one memory and computer program code configured to, with the at least one processor, cause the performance of the apparatus.

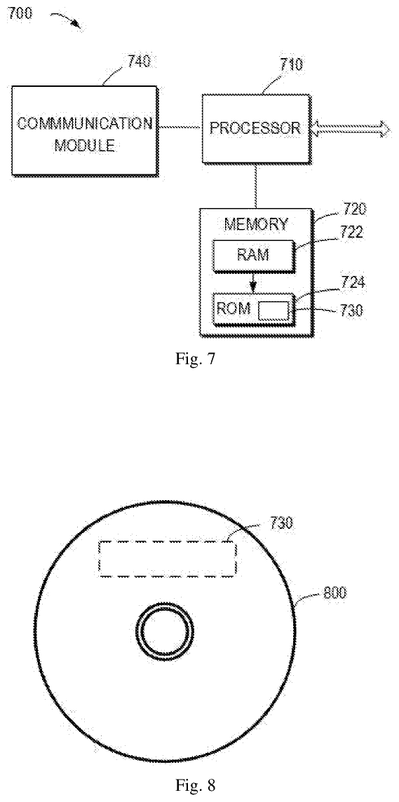

FIG. 7 is a simplified block diagram of a device 700 that is suitable for implementing embodiments of the present disclosure. The device 700 may be provided to implement the communication device, for example the terminal device 101, the network device 111 as shown in FIG. 1. As shown, the device 700 includes one or more processors 710, one or more memories 740 coupled to the processor 710, and one or more transmitters and/or receivers (TX/RX) 740 coupled to the processor 710.

The TX/RX 640 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 1020. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 6c. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 200, 300, and 400, and process 500 as described above with reference to FIGS. 2-6c. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-39. (canceled)

40. A terminal device, comprising:
at least one processor; and
at least one memory including computer program codes;
the at least one memory and the computer program codes are configured to, with the at least one processor, cause the terminal device to:
perform a transmission, in small data transmission (SDT) procedure utilizing a resource associated with a selected synchronization signal and physical broadcast channel block (SSB), wherein the SSB is selected from one or more SSBs available for the SDT procedure; and
monitor the selected SSB for a downlink reception for a period of time, wherein the period of time is dependent on at least quality of the selected SSB.

41. The terminal device of claim 40, wherein the period of time expiries in accordance with determination that quality of the selected SSB is below a threshold.

42. The terminal device of claim 40, wherein the SDT procedure is performed based on a configured grant.

43. The terminal device of claim 40, wherein the SDT procedure is performed based on a random access procedure.

44. The terminal device of claim 43, wherein the terminal device is further caused to:
perform another random access procedure when the quality of the selected SSB is below a threshold.

45. A network device, comprising:
at least one processor; and
at least one memory including computer program codes;
wherein the at least one memory and the computer program codes are configured to, with the at least one processor, cause the network device to:
configure a period of time for a terminal device by a higher layer signaling, wherein the terminal device is configured to monitor a synchronization signal and physical broadcast channel block (SSB) for a downlink (DL) reception for the period of time, and wherein the period of time is indicated by any one of: a timer, a time window or a counter of slot for the terminal device.

46. The network device of claim 45, wherein the network device is further caused to:
receive, from the terminal device, an uplink (UL) transmission in small data transmission (SDT) procedure, utilizing a resource associated with a selected SSB, wherein the SSB is selected by the terminal device from one or more SSBs available for the SDT; and
perform a DL transmission, utilizing a resource associated with the selected SSB for a period of time, wherein the period of time is based on at least one of: a timer, a time window, a counter of slot, a part of the SDT procedure at the network device.

47. The network device of claim 46, wherein the period of time is extended upon any DL transmission on the selected SSB.

48. The network device of claim 46, wherein the period of time is extended by any of:
restarting the timer;
extending the time window; and
resetting the counter of slot.

49. The network device of claim 46, wherein the network device is further caused to:
receive another UL transmission in the SDT procedure utilizing a resource associated with the selected SSB until the period of time is expired.

50. The network device of claim 46, wherein the network device is further caused to:
receive another UL transmission in the SDT procedure utilizing a resource associated with another SSB different from the selected SBB during the period of time.

51. The network device of claim 50, wherein an SSB is reselected after any DL transmission on the selected SSB.

52. The network device of claim 45, wherein the transmission is an initial transmission in the SDT procedure.

53. The network device of claim 45, wherein the transmission is a subsequent transmission in the SDT procedure.

54. The network device of claim 45, wherein for a subsequent transmission in the SDT procedure, another SSB from the selected SBB is reselected during the SDT procedure.

55. The network device of claim 45, wherein the SDT procedure is performed based on configured grant.

56. The network device of claim 45, wherein the SDT procedure is performed based on random access procedure.

57. A method at a terminal device comprising:
performing a transmission, in small data transmission (SDT) procedure utilizing a resource associated with a selected synchronization signal and physical broadcast channel block (SSB), wherein the SSB is selected from one or more SSBs available for the SDT procedure; and
monitoring the selected SSB for a downlink reception for a period of time, wherein the period of time is dependent on at least quality of the selected SSB.

58. The terminal device of claim 47, wherein the period of time expiries in accordance with determination that quality of the selected SSB is below a threshold.

59. The terminal device of claim 47, wherein the SDT procedure is performed based on a configured grant.
